(19) United States
(12) Patent Application Publication
(10) Pub. No.: US 2020/0005408 A1
(43) Pub. Date: Jan. 2, 2020

(54) REVERSE CONSTRUCTION PROJECT AUCTION SYSTEM AND METHOD

(71) Applicant: Dallas Raymond Nugent, Dallas, TX (US)

(72) Inventor: Dallas Raymond Nugent, Dallas, TX (US)

(21) Appl. No.: 16/021,817

(22) Filed: Jun. 28, 2018

(51) Int. Cl. G06Q 50/08; G06Q 30/06; G06Q 30/02; G06Q 30/00

(52) U.S. Cl. CPC G06Q 50/08; G06Q 30/0611; G06Q 30/0277; G06Q 30/018; G06Q 30/0282

(57) ABSTRACT

A construction project management method includes receiving project details from a general contractor; posting details about the project to an online platform; receiving one or more bids from one or more sub-contractors for the project; receiving an acceptance of one of the one or more bids from the general contractor; transferring legal notice to the winning subcontractor; and facilitating contract formation between the general contractor and the one or more sub-contractors; a lowest bid is a starting point for additional bids by sub-contractors.

### BACKGROUND

### 1. Field of the Invention

The present invention relates generally to project bid systems, such as are common in contract projects, and more specifically, to a construction project system and method for collecting bids from subcontractors for general contractors already hired for a project, thereby eliminating the uncertainty associated with subcontractor bidding as is common in the art.

### 2. Description of Related Art

Project bidding systems and methods are well known in the art and are effective means for project owners to hire general contractors and general contractors to hire subcontractors. For example, FIG. 1 depicts a flowchart 101 of a general bid method, wherein a project owner gives out details of a project to general contractors, as shown with box 103. The general contractors then share details with subcontractors to collect a plurality of bids therefrom, as shown with box 105. Based on the subcontractor bids, the general contractor then inputs a bid to the project owner, as shown with box 107. The project owner then hires a general contractor based on bids received, as shown with box 109.

One of the problems commonly associated with method 101 is inaccurate bidding and uncertainty. For example, subcontractors receive many opportunities to bid on jobs, and do not always put in the time and effort to ensure that they are making an accurate bid. This is due to the fact that for their bid to be accepted, they have to beat all other subcontractors, and then also the general contractor that they are bidding on must win the project. Alternatively, the subcontractor may have to input bids with a plurality of general contractors in order to increase their odds of being hired for a job, thereby being inefficient.

Accordingly, although great strides have been made in the area of project bidding systems and methods, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a flowchart of a common project bidding method;

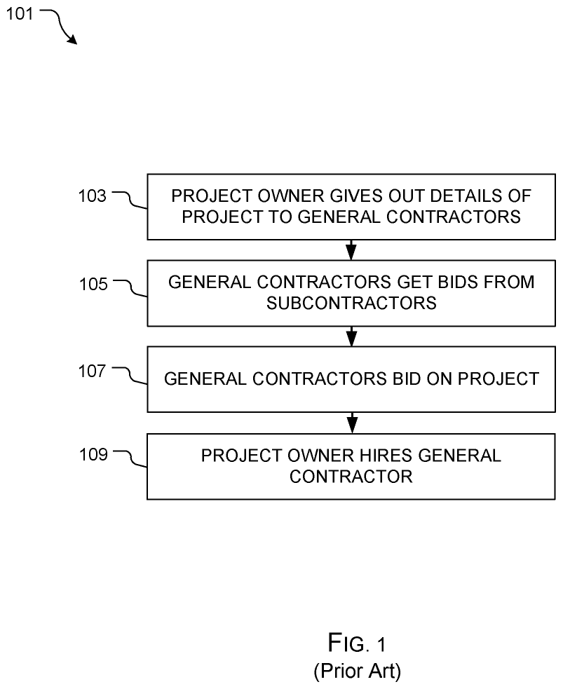

FIG. 2 is a simplified diagram of a reverse construction project auction system in accordance with a preferred embodiment of the present application;

FIG. 3 is a simplified diagram of a reverse auction platform of FIG. 2;

FIG. 4 is a simplified diagram of the features of a subcontractor portal of FIG. 2; and

FIG. 5 is a flowchart of the method of use of the system of FIG. 2.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional project bid systems. Specifically, the present invention provides for improved information sharing between the parties, as well as for increase efficiency for the subcontractors who are bidding on jobs already awarded or proposed to a general contractor. In addition, the present invention provides a means for contract creation between the parties. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

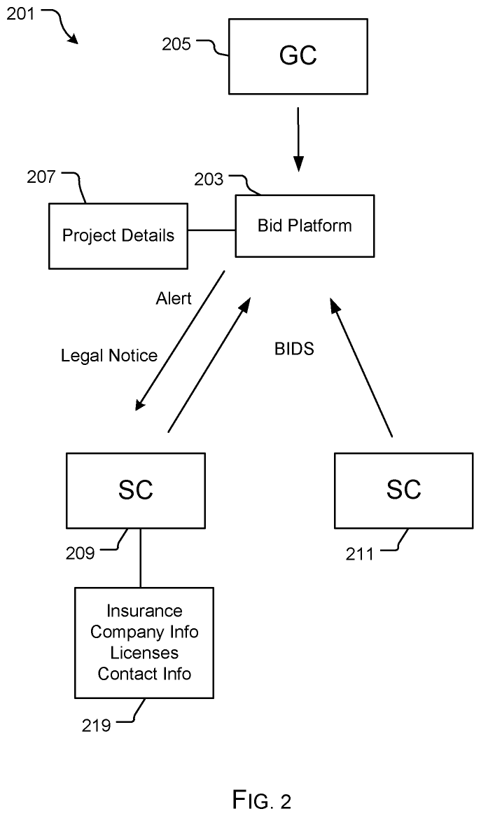

Referring now to the drawings wherein like reference characters identify corresponding or similar elements throughout the several views, FIG. 2 depicts a diagram of a reverse construction project auction system 201 in accordance with a preferred embodiment of the present application. It will be appreciated that system 201 overcomes one or more of the above-listed problems commonly associated with conventional project bidding systems.

In the contemplated embodiment, system 201 includes a bid platform 203 configured to receive project details 207 from a general contractor 205, wherein the project details 205 are sufficient for subcontractors 209, 211 to accurately bid on the project. It should be understood that the GC 205 has responsibility for the project by a project owner/manager, and therefore, the SCs 209, 211 only have to bid with the particular GC in order for a chance to win the work. It should be appreciated that each bid drives the price of the work down, thereby providing the means for the general contractor to save money and work with the most efficiently priced subcontractor.

It will be understood that the CG 205, SCs 209, 211 and any other entity using the system 201 could have profiles associated therewith including data to identify the respective entity.

During the bidding process, each SC 209, 211 can receive alerts when their last bid is outbid, thereby providing the desired information for an SC to continually lower their own bid, driving the cost further down. It is contemplated that each bid can be verified, such as through a verified statement of a relevant party.

In some embodiments, it is contemplated that the subcontractors 209, 211 must provide verifying and important details 219, such as insurance information, contact information, company information, and relevant licenses, thereby again providing the general contractor 205 with relevant details to make a decision.

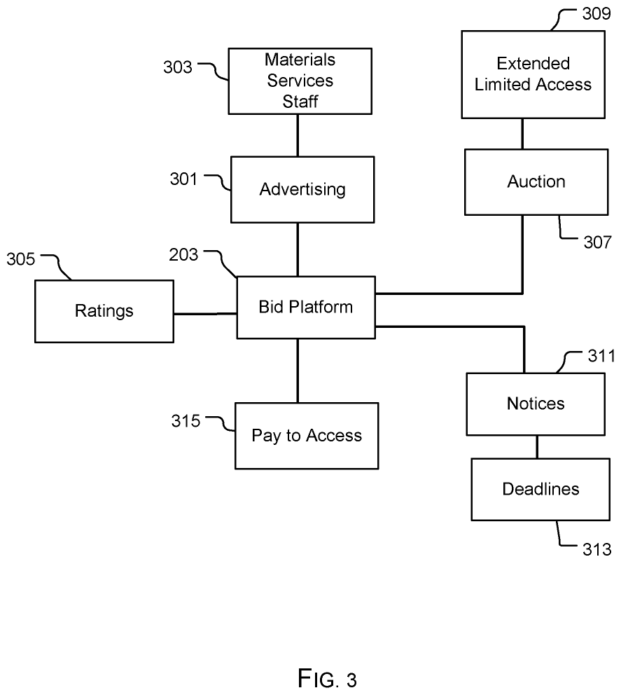

In FIG. 3, a diagram depicts additional features of platform 203, including an advertising means 301, wherein a variety of advertisements 303 created by general contractors, subcontractors, suppliers, service providers, etc., can be created and displayed, thereby providing a means for general contractors and subcontractors to hire staff, purchase materials, hire service providers, etc.

Platform 203 further includes ratings 305, wherein subcontractors, general contractors, service providers, etc. can be rated, thereby providing additional information on all relevant parties.

In addition, platform 203 can provide options 309 associated with an auction 307, the options can include, among others, the ability to extend the auction if a target price is not met, the ability to limit the auction to specific parties, such as prior subcontractors that the general contractor is familiar with e.g. a sealed auction, or any other option.

Further, platform 203 includes a notice function 311, wherein notices can be sent to subcontractors, such as deadline reminders 313, the deadline reminders being for a bid, reminders for a completion time, payments, document creation, etc. In addition, notices can be sent to other parties, such as the general contractor, when a bid is placed, when work is completed, etc. This allows for immediate notification for updates.

In the preferred embodiment, it is contemplated that the platform 203 can receive payment 315 to access and use the platform, wherein general contractors pay a percentage of their profits and/or savings to a platform management company, thereby providing a means for the platform management company to profit. Additionally, the use of site specific vouches, tokens or the like could be used to facilitate the bidding.

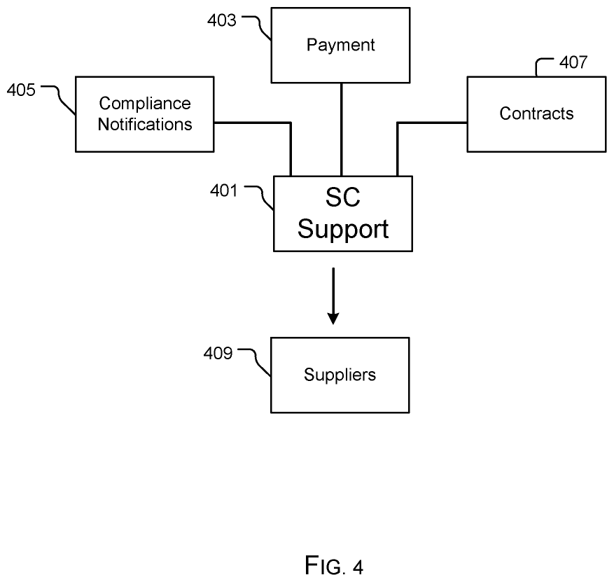

In FIG. 4, a diagram depicts features associated with a subcontractor portal 401, wherein the subcontractor can receive needed support such as the ability to make and receive payments 403. In addition, the subcontractor can receive necessary compliance notifications 405. In the preferred embodiment, one or more contracts 407 can be automatically created and pre-populated upon the hiring of a subcontractor, the one or more contracts 407 can include the details of the job, such as pricing, dates, materials, parties, etc. It should be appreciated that the contracts can be formed to be electronically signed/acknowledged by the parties, thereby providing for a convenient means to secure the agreements.

Further, it should be appreciated that communication with suppliers 409 can be facilitated through the subcontractor portal 401, thereby again increasing the efficiency associated with a construction project.

It should be appreciated that one of the unique features believed characteristic of the present application is the creation of a platform that can be used for reverse auctioning of construction jobs, and wherein the platform includes additional features, such as the creation of a contract, to streamline and increase efficiency of construction projects.

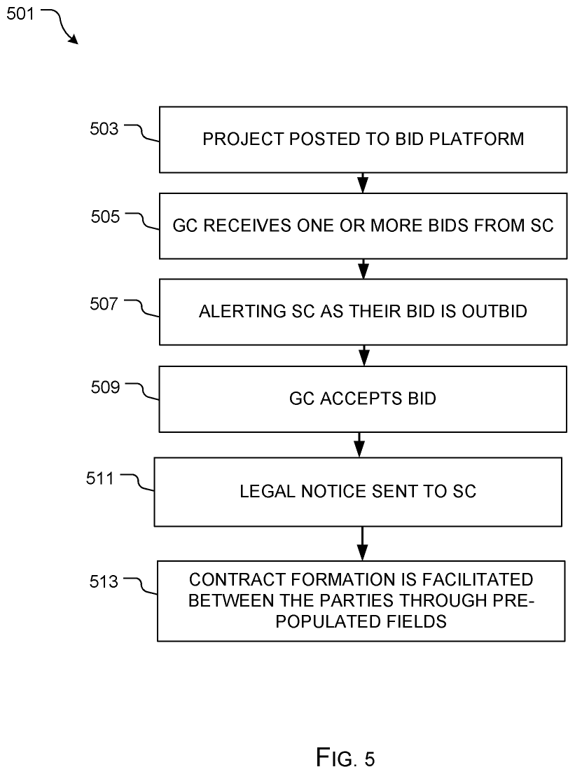

In FIG. 5, a flowchart 501 depicts the method of system 201. During use, after the GC is responsible for a project and posts all relevant details of the project to the bid platform, one or more SCs can bid on the project, as shown with boxes 503, 505. The SCs can receive notifications that they have been outbid, thereby providing the needed information to drive the cost down, as shown with box 507. Once the GC accepts one of the bids, legal notice is sent to the winning SC, and one or more contracts can be created between the parties, thereby providing for security relating to the agreement, as shown with boxes 509, 511, 513.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A reverse auction construction project management method, comprising:
receiving a plurality of details about a project from a general contractor;
posting the plurality of details about the project to an online platform accessible by a plurality of subcontractors;
receiving one or more bids from one or more subcontractors for the project;
receiving an acceptance of one of the one or more bids from the general contractor;
providing legal notice to the one or more subcontractors about their winning of the project; and
facilitating contract formation between the general contractor and the one or more sub-contractors;
wherein a lowest bid is a starting point for additional bids by sub-contractors.

2. The method of claim 1, further comprising:
receiving ratings from the general contractor, sub-contractors or suppliers for the at least one of the one or more general contractors, one or more sub-contractors or one or more of the suppliers.

3. The method of claim 1, wherein each of the one or more bids is verified.

4. The method of claim 1, wherein the facilitating contract formation comprises creating one or more contracts with pre-populated fields.

5. The method of claim 1, further comprising:
collecting pre-verifying information from the one or more subcontractors.

6. The method of claim 5, wherein the pre-verifying information comprises one or more of:
insurance information;
one or more licenses;
company information; and
contact information.

7. The method of claim 1, further comprising:
alerting each of the one or more subcontractors as they are outbid.

8. The method of claim 1, further comprising:
connecting the one or more subcontractors to one or more suppliers via the online platform.

9. The method of claim 1, further comprising:
advertising through the online platform to the one or more subcontractors or the general contractors;
wherein advertising includes advertising by one or more of the general contractors, the one or more subcontractors, or the one or more suppliers.

10. The method of claim 1, further comprising:
providing one or more options for an auction, the one or more options including an option to extend a time of the auction and an option to limit access to the option.

11. The method of claim 1, further comprising:
transmitting one or more notices to the one or more subcontractors relating to one or more deadlines.
